(19) United States
(12) Patent Application Publication
(10) Pub. No.: US 2010/0146838 A1
(43) Pub. Date: Jun. 17, 2010

(54) LOBSTER SNARE DEVICE

(76) Inventor: Thomas A. Contreras, Port Charlotte, FL (US)

Correspondence Address: EDWARD M. LIVINGSTON, PA, 963 TRAIL TERRACE DRIVE, NAPLES, FL, 34103, US

(21) Appl. No.: 12/337,083

(22) Filed: Dec. 17, 2008

(51) Int. Cl. A01M 23/34

(52) U.S. Cl. 43/87; 43/4; 43/5

(57) ABSTRACT

A lobster snare device (1) that permits a user to catch a lobster without harming the environment or the lobster. A telescoping internal pole (3) is located inside an external pole (2). A loop (9), located on a distal end of the internal pole, may be made smaller or bigger by pushing or pulling the internal pole. The proximal end of the internal pole extends from the external pole and has a handle/dive indicator (13) attached to it which is preferably colored red so as to indicate where a user is located while in the water. The proximal end may also have a dive flag (14) attached to it to warn boaters of the user's location while in the water. While the lobster snare device is not in use, the dive flag may be rolled around the handle/dive indicator and covered by an outer cover (15).

### BACKGROUND OF THE INVENTION

This invention relates to snares, more particularly a lobster snare device wherein a user can easily control the tension of a loop and having a dive indicator incorporated into the lobster snare device to alert third parties to a user's location while using the lobster snare device.

Currently, lobster snare devices use a loop located on one end of a pole and complex trigger devices to tighten the loop around a lobster. The use of trigger devices in conventional lobster snare devices is dangerous to lobsters and to sensitive coral reefs where lobsters are usually found. This is due to the fact that users cannot control the tension of the loop when using lobster snare devices having trigger devices. The high tension of the loop can harm or even kill immature lobsters, which are required to be released back into the water. Further, the high tension and speed with which the loop closes can cause sensitive plant life to get caught in the loop. In additions trigger devices are prone to failure.

Another problem posed to conventional lobster snare users is the danger of being struck by water craft such as boats or jet skis while snorkeling or diving for lobsters because conventional lobster snare devices do not provide any indicators to alert third parties to the location of the user while in and/or under the water.

Thus, a need exists for a lobster snare device in which a user can control the tension of the snare loop and which provides a dive indicator to alert third parties to a user's location while using the lobster snare under water.

The relevant patents of prior art includes the following references:

| Patent/Ser. No. | Inventor | Issue/Publication Date |
|---|---|---|
| 6,684,562 | Schade | Feb. 03, 2004 |
| D450,801 | Fundak | Nov. 20, 2001 |
| 5,979,106 | Butler | Nov. 09, 1999 |
| 5,479,739 | Livingston | Jan. 02, 1996 |
| 3,540,769 | Rosser | Nov. 17, 1990 |
| 2,582,339 | Krueger | Jan. 15, 1952 |
| 2,499,511 | Koger | Mar. 07, 1950 |
| 793,693 | Thompson | Apr. 04, 1905 |

### SUMMARY OF THE INVENTION

The primary object of the present invention is to provide a lobster snare device in which a user may easily control the tension of the loop.

Another object of the present invention is to provide a lobster snare device in which a user may easily control the speed with which the loop closes.

A further object of the present invention is to provide a lobster snare device which is safe for the environment.

Another object of the present invention is to provide a lobster snare device which will not hurt or kill lobsters thereby making it possible to release immature lobsters back to the water unharmed.

A further object of the present invention is to provide a lobster snare device which may be used to alert third parties to a user's location while using the lobster snare.

The present invention fulfills the above and other objects by providing a lobster snare device which permits a user to catch a lobster without harming the environment by providing an elongated, telescoping internal pole inside an external pole. A loop is located on a distal end of the internal pole, which is preferably made of cable, and is secured to the distal end of the internal pole by inserting the cable through a hole located in the internal pole, inserting the end of the cable through a first hole in a distal cap located on the distal end of the external pole inserting the end of the cable back through a second hole in the distal cap and securing the end of the cable to itself via a clamp. A plastic tube/sleeve is preferably located on the loop so as to minimize damage to lobsters during use. The proximal end of the internal pole extends from the external pole and has a handle/dive indicator attached to it which is preferably colored red so as to indicate where a user is located beneath the water surface. In addition to or in place of the colored handle/dive indicator, the proximal end of the internal pole may also have a dive flag attached to it to warn boaters of the user's location while in and/or under water. While the lobster snare device is not in uses the dive flag may be rolled around the handle/dive indicator and covered by an outer cover.

To use the lobster snare device, a user first pushes the internal pole to create a desired loop size, then places the loop around a lobster and finally pulls the internal pole to tighten the loop around the lobster.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed descriptions reference will be made to the attached drawings in which;

FIG. 1 is a side plan view of a lobster snare device of the present invention;

FIG. 2 is a front perspective view of a lobster snare device with a cover for storing a dive flag 14 of the present invention;

FIG. 3 is a side view of a lobster snare device having a dive flag attached to the handle of the present invention; and

FIG. 4 is a side plan view of a lobster snare device with a cover storing a dive flag of the present invention.

### DESCRIPTION OF THE PREFERRED EMBODIMENTS

For purposes of describing the preferred embodiment, the terminology used in reference to the numbered components in the drawings is as follows:

```
  1. lobster snare device
  2. external pole
  3. internal pole
  4. proximal end
  5. distal end
  6. proximal cap
  7. distal cap
  8. cable
  9. loop
10. cotter pin
11. clamp
12. protective sleeve
13. handle/dive indicator
14. dive flag
15. cover
16. cover cap
17. first hole
18. second hole
19. hitch pin
20. vertical indicator line
21. horizontal indicator line
```

With reference to FIG. 1, a side plan view of a lobster snare device 1 of the present invention is shown. The lobster snare device has a proximal end 4 and a distal end 5. An internal pole 3 is telescopically mounted inside an external pole 2 so that one end of the internal pole 3 extends out of the external pole 2 through a proximal cap 6 located at the proximal end 4 of the lobster snare device 1. A cable 8, such as wire, rope or metal cable, is attached to the internal pole 3 Ends of the cable 8 may be connected together by a clamp 11 or other means such as welding thereby creating a loop 9. The loop 9 extends from the distal end 5 of the external pole 2 through a distal cap 7 having a first hole 17 and a second hole 18. The first hole 17 and second hole 18 keep the loop 9 from touching in the center. A protective sleeve 12, such as plastic tubing, covers the wire 8 on an outer portion of the loop 9 which extends from the distal end 5 of the external pole 2. A brightly colored handle/dive indicator 13 is located at the proximal end of the lobster snare device 1 and attached to the internal pole 3 for providing a grip for the user and provides a grip for a user and may be used to alert third parties to the user's location while using the lobster snare device 1.

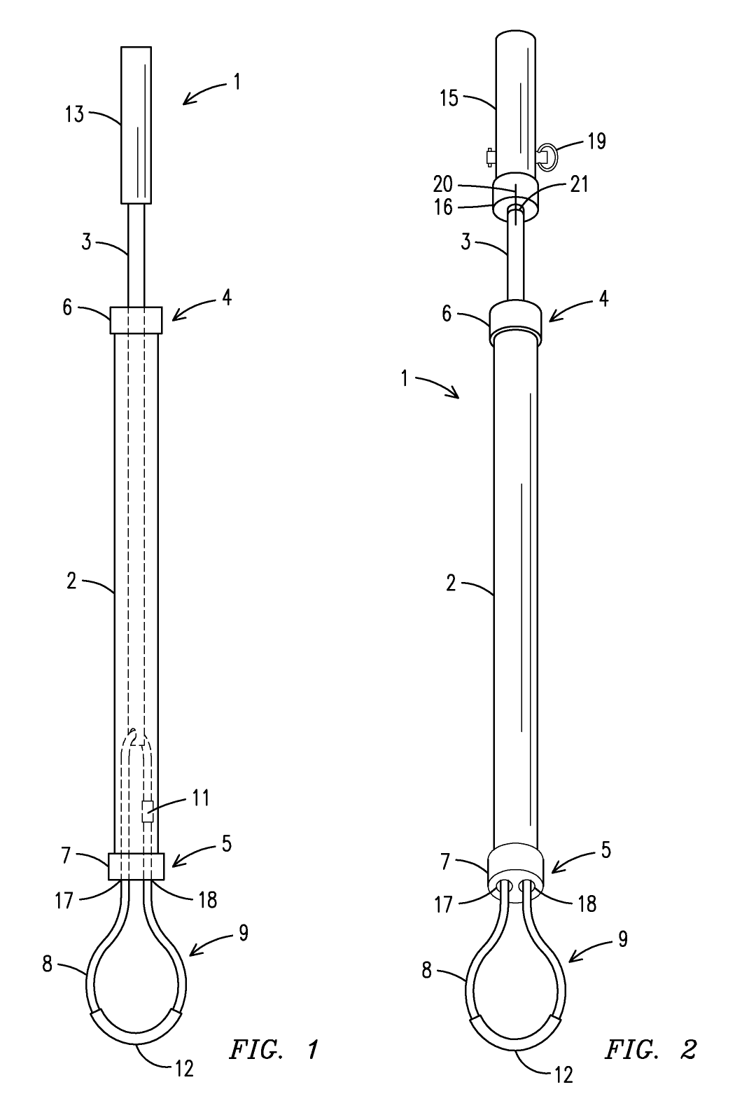

Referring to FIG. 2, a front perspective view of a lobster snare device 1 with a cover 15 for storing a dive flag 14 of the present invention is shown. The loop 9 extends from the distal end 5 of the external pole 2 through a distal cap 7 having a first hole 17 and a second bole 18. The first hole 17 and second hole 18 keep the loop 9 from touching in the center and help the loop 9 to maintain its shape. When not in use, the dive flag 14 may be wrapped around the handle/dive indicator 13 and the cover 15 may be placed over the dive flag 14 as shown. The cover 15 fits into the cover cap 16 and may be held in place by threads located on the cover 15 and cap 16, a cotter pin 10, a hitch pin 19 as shown here, etc. To attach the cover to the cap using the hitch pin 19, a user simply lines up the horizontal indicator lines 21 and vertical indicator lines 20 and then inserts the hitch pin 19 through the cover 15 and internal pole 3.

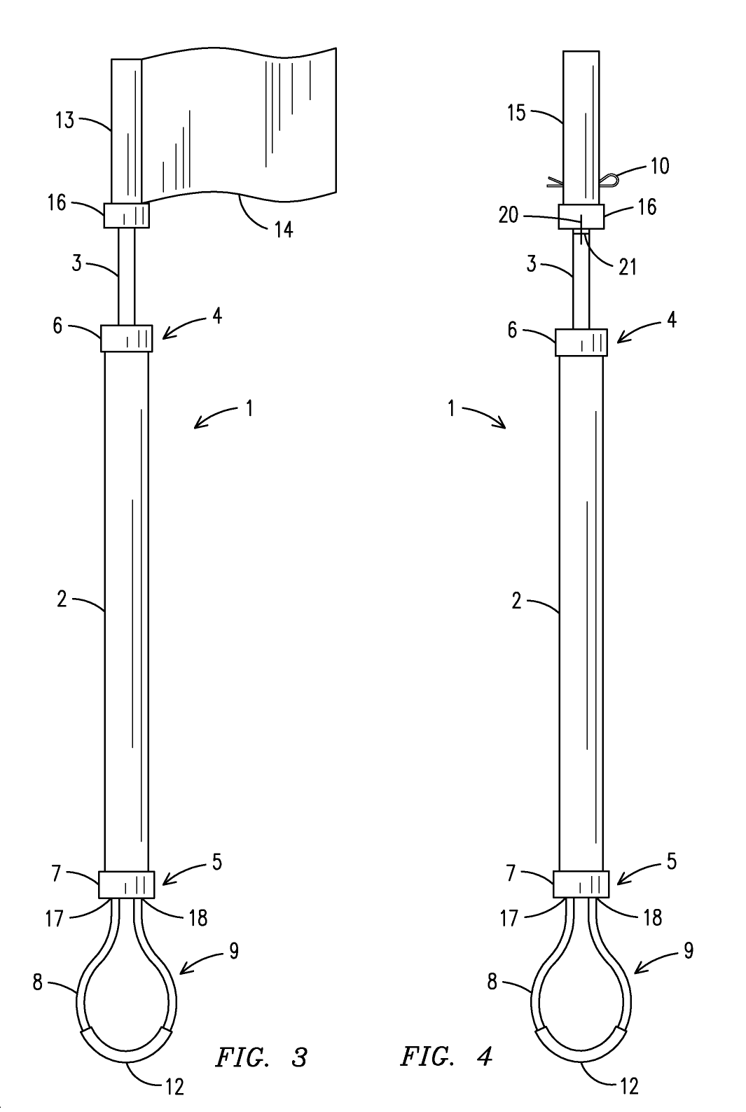

Referring to FIG. 3, a side view of a lobster snare device 1 having a dive flag 14 of the present invention is shown. The dive flag 14 is attached to the handle/dive indicator 13 and is used to alert third parties to the user's location while using the lobster snare device 1. A cover cap 16 is attached to the internal rod just below the handle/dive indicator 13.

Referring to FIG. 4, is a side plan view of a lobster snare device 1 with a cover 15 for storing a dive flag 14 of the present invention is shown. When not in use, the dive flag 14 may be wrapped around the handle/dive indicator 13 and the cover 15 may be placed over the dive flag 14 as shown. The cover 15 fits into the cover cap 16 and may be held in place by threads located on the cover 15 and cap 16, a cotter pin 10 as shown here, a hitch pin, etc 19. To attach the cover to the cap using the cotter pin 10, a user simply lines up the horizontal indicator lines 21 and vertical indicator lines 20 and then inserts the cotter pin 10 through the cover 15 and internal pole 3.

Although a preferred embodiment of a lobster snare device has been disclosed, it should be understood, it is not to be limited to the specific form or arrangement of pars herein described and shown. It will be apparent to those skilled in the art that various changes may be made without departing from the scope of the invention and the invention is not be considered limited to what is shown and described in the specification and drawings.

Having thus described my invention, I claim:

1. A lobster snare device comprising:
a hollow pole having a proximal end and a distal end;
an internal pole telescopically mounted inside said hollow pole having a proximal end and a distal end;
a cable attached to the distal end of said internal pole thereby creating a loop which extends from the distal end of said external pole; and
a handle/dive indicator attached to said lobster snare device for alerting third parties to a user's location while using the lobster snare device.

2. The lobster snare device of claim 1 wherein:
said cable passes through a hole located on the distal end of said internal shaft;
said cable passes through a first hole located on a distal cap;
said cable passes back through a second hole located on the distal cap; and
ends of said cable are connected together thereby creating a loop.

3. The lobster snare device of claim 2 wherein:
the ends of said cable are connected together by a clamp.

4. The lobster snare device of claim 1 wherein:
said cable is a metal cable.

5. The lobster snare device of claim 1 wherein:
said cable is a wire.

6. The lobster snare device of claim 1 wherein:
said cable is a rope.

7. The lobster snare device of claim 1 wherein:
said cable is covered by a protective sleeve.

8. The lobster snare device of claim 7 wherein:
said protective sleeve is plastic tubing.

9. The lobster snare device of claim 1 wherein:
said handle/dive indicator comprises a colored handle attached to the proximal end of said internal pole.

10. The lobster snare device of claim 1 wherein:
said handle/dive indicator further comprises a flag attached to said colored handle.

11. The lobster snare device of claim 1 wherein:
said handle/dive indicator comprises a flag attached to the proximal end of said internal pole.

12. The lobster snare device of claim 11 further comprising:
a cover removably attached to the proximal end of said internal pole which covers and stores said dive flag when not in use.

13. The lobster snare device of claim 10 further comprising:
a cover removably attached to the proximal end of said internal pole which covers and stores said dive flag when not in use.

14. The lobster snare device of claim 12 further comprising:
a cover cap attached to the proximal end of said internal pole which seal said cover while in use.

15. The lobster snare device of claim 13 further comprising:
a cover cap attached to the proximal end of said internal pole which seal said cover while in use.

16. The lobster snare device of claim 12 wherein:
said cover is attached to the proximal end of said internal pole by a cotter pin.

17. The lobster snare device of claim 13 wherein:
said cover is attached to the proximal end of said internal pole by a cotter pin.

18. The lobster snare device of claim 12 wherein:
said cover is attached to the proximal end of said internal pole by threads.

19. The lobster snare device of claim 13 wherein:
said cover is attached to the proximal end of said internal pole by threads.

20. The lobster snare device of claim 12 wherein:
said cover is attached to the proximal end of said internal pole by a hitch pin.

21. The lobster snare device of claim 13 wherein:
said cover is attached to the proximal end of said internal pole by a hitch pin.

22. The lobster snare device of claim 12 wherein:
said cover is brightly colored so it may be used for alerting third parties to a user's location while said dive flag is not in use.

23. The lobster snare device of claim 13 wherein:
said cover is colored so it may be used for alerting third parties to a user's location while said dive flag is not in use.
